(19) United States
(12) Patent Application Publication
(10) Pub. No.: US 2010/0033669 A1
(43) Pub. Date: Feb. 11, 2010

(54) DISPLAY DEVICE AND METHOD FOR MANUFACTURING A LIQUID CRYSTAL DISPLAY DEVICE

(75) Inventors: Kazumi Iizawa, Ishikawa-ken (JP); Tetsuya Kawamura, Saitama-ken (JP); Tetsuo Morita, Saitama-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toshiba Mobile Display Co., Ltd., Tokyo (JP)

(21) Appl. No.: 12/536,246

(22) Filed: Aug. 5, 2009

(30) Foreign Application Priority Data
Aug. 5, 2008 (JP) 2008-201847

(51) Int. Cl. G02F 1/1339; G02F 1/13

(52) U.S. Cl. 349/155; 349/187

(57) ABSTRACT

A display device has a pair of substrates arranged opposite to each other, a light modulation layer interposed between the pair of substrates, and spacers arranged between the pair of substrates to maintain a gap therebetween. A display area is formed by the pair of substrates, the modulation layer and the spacers, and includes a plurality of pixels arranged in rows and columns of a matrix. The spacers are arranged between adjacent pixels in the column direction so that an area density of the spacers continuously changes from an edge portion to a predetermined portion in the display area extending in the row direction.

### CROSS-REFERENCE TO RELATED APPLICATION

This application is based upon and claims the benefit of priority from prior Japanese Patent Application No. 2008-201847 filed Aug. 5, 2008, the entire contents of which are incorporated herein by reference.

### BACKGROUND OF THE INVENTION

1. Field of the Invention

The present invention relates to a display device having a plurality of columnar spacers arranged on one of a pair of substrates to maintain a gap between the pair of substrates.

2. Description of the Background Art

Liquid crystal display devices are widely used as display devices for various kinds of equipment such as personal computers, OA equipment, and TV sets because the display devices have many advantages such as lightness, compactness and low power consumption. In recent years, the liquid crystal display device has also been used in mobile terminal equipment such as a mobile phone, a car navigation device and a game player. Such liquid crystal display devices include a liquid crystal display panel formed of an array substrate, a counter substrate attached to the array substrate by a seal element and a liquid crystal layer held therebetween.

Further, spacer particles made of plastic beads or columnar spacers are arranged to maintain the gap (cell gap) between the substrates. Such beads and/or columnar spacers may be made by selectively patterning a compound resin.

As a method for arranging the spacer particles on a substrate, a wet dispersion method may be used to disperse the spacer particles on the substrate using a solvent such as isopropanol. Alternatively, a dispersion method using air pressure instead of a solvent may be used. However, in these dispersion methods, the spacer particles are spit from a nozzle of a spreader and free fall onto a substrate. Accordingly, a distribution density of the dispersed particles may locally vary and it is difficult to maintain an equal gap between the substrates, which results in uneven display.

One proposed dispersion method uses an inkjet equipment in order to solve the above problems. Another proposed method to make the gap between the substrates uniform arranges particle spacers so that an average distribution density of the dispersed particle spacers in an area is different from those of other areas as described in the Japanese Patent Application No. 2006-201431.

However, the above methods have the following problems. First, when the spacer particles are used, control of the average distribution density of the dispersed spacer particles is possible, but arrangement of the dispersed spacer particles in a predetermined portion in a pixel is difficult. Accordingly, when the spacer particles are used, the dispersed spacer particles may be arranged on a transmissive portion of the pixel, which may result in light leak, cause a display defect and a decrease in contrast. In a liquid crystal display device which uses spherical-shaped or rod shaped spacer particles, the spacer particles contact with the substrates in a point or in a line when the substrates are attached by seal elements. Accordingly, alignment films or transmissive electrodes may be broken, which may result in a display defect.

Second, since there is a discontinuity of the spacer dispersion, the gap between the substrates may significantly change at the discontinuous portions. Therefore, it is difficult to reliably make the gap uniform between the substrates.

Third, when columnar spacers are provided in a display area on the array substrate, it is desirable to form the columnar spacers from the same material and using the same manufacturing process as a shield layer arranged in a frame region. This reduces the process steps and lowers costs. However, it is difficult to form the spacers on the shield layer, which results in difficulty in maintaining an equal gap between the substrates in the frame region and in the display area. Accordingly, the gap between the substrates in the central portion of the active area may be different from the gap in the edge portion of the active area, resulting in unevenness of a gap in the edge portion of the active area.

In a one drop fill method, the sealing layer is applied to each display area to surround the display area. Then, the liquid crystal material is poured into the display area surrounded by the sealing layer. In the one drop method, an excess amount of the liquid crystal material may be poured. In such a case, when the substrates are attached, the gap between the substrates is non-uniformly formed. That is, the gap in the central portion may be larger than the gap in the peripheral portion, and some dispersion may occur.

When three colored resins as color filters are formed on an array substrate, shield layers, a counter electrode and an overcoat layer interposed therebetween are formed in the counter substrate so that the area of the shield layer is made significantly small compared to the peripheral portion. The thickness of the overcoat layer in the edge portion of the display area also becomes larger than that in the central portion. Therefore, some variations between the gaps in the edge portion and in the central portion of the display area are generated.

### BRIEF SUMMARY OF THE INVENTION

The present invention has been made to address the above mentioned problems. One object of the present invention is to provide a display device in which a gap between the substrates is maintained uniformly by arranging columnar spacers in a display area so that an area density of the spacers continuously changes from an edge portion to an predetermined central portion in the display area.

Thus, according to one aspect of the invention, there is provided a display device, comprising: a pair of substrates arranged opposite to each other; a light modulation layer interposed between the pair of substrates; spacers arranged between the pair of substrates to maintain a gap therebetween; a display area formed of the pair of substrates, the modulation layer and the spacers and including a plurality of pixels extending in a row and a column directions in a matrix, and wherein the spacers are arranged so that an area density of the spacers provided in the display area continuously changes from an edge portion to a predetermined portion in the display area, and where the area density of spacers is obtained from

area density of spacers: (B/A)×(C/D)

where:

A: is a predetermined number of pixels arranged along one column line,

B: is the number of the spacers arranged between adjacent pixels of a predetermined number of pixels arranged along one column line,

C: is the area of each spacer that occupies surfaces of the substrates, and

D: is the area of each pixel in the display area.

According to another aspect of the invention, there is provided a method for manufacturing a liquid crystal display device including pixels extending in a row and a column directions in a matrix, comprising: forming scan lines, signal lines and switching transistors on an array substrate; connecting a plurality of switching transistors to the scan lines and signal lines; forming color filter layers formed on the switching transistors corresponding to each pixel; forming columnar spacers between adjacent pixels on the counter substrate to maintain a gap between the array substrate and the counter substrate; opposing the counter substrate and the array substrate; injecting liquid crystal material into the gap between the counter substrate and the array substrate, and wherein the spacers are arranged so that an area density of the spacers provided in the display area continuously changes from an edge portion to a predetermined portion in the display area.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings. However, the accompanying drawings and their exemplary depictions do not in any way limit the scope of the invention embraced by this specification. The scope of the invention embraced by the specification and drawings are defined by the words of the accompanying claims.

FIG. 1A is a schematic plan view of a liquid crystal device according to a first exemplary embodiment of the invention,

FIG. 1B is a schematic graph of an area density of spacers provided between a pair of substrates taken along a line A-A of FIG. 1A,

FIG. 1C is a schematic graph of an area density distribution of spacers provided between the pair of substrates taken along a line A-A of FIG. 1A,

FIG. 2 is a cross-sectional view of the liquid crystal device of FIG. 1A according to the first exemplary embodiment of the invention,

FIG. 3A is a schematic plan view of a liquid crystal device according to the first exemplary embodiment of the invention,

FIG. 3B is a schematic graph of an area density distribution of the spacers provided between substrates taken along a line B-B in FIG. 3A,

FIG. 4 is a circuit diagram of the display device according to the first exemplary embodiment of the invention,

FIG. 5A is a schematic plan view of a display area and a frame area in the liquid crystal panel according to a second exemplary embodiment of the invention,

FIG. 5B is a schematic graph of an area density distribution of the spacers provided between the pair of substrates taken along a line C-C of FIG. 5A,

FIG. 6 is a cross-sectional view of the liquid crystal device according to a third exemplary embodiment of the invention,

FIG. 7 is a cross-sectional view of the liquid crystal device in FIG. 8A according to a fourth exemplary embodiment of the invention,

FIG. 8A is a schematic plan view of a display area and a frame area in the liquid crystal panel of FIG. 7 according to the fourth exemplary embodiment of the invention, and

FIG. 8B is a schematic graph of an area density distribution of spacers provided between the pair of substrates taken along a line E-E in FIG. 8A.

### DETAILED DESCRIPTION OF THE INVENTION

In the following, the present invention will be discussed by describing preferred embodiments, and by referring to the accompanying drawings. However, those skilled in the art will realize other applications and modifications within the scope of the invention as defined in the enclosed independent claims.

A liquid crystal display device according to an exemplary embodiment of the present invention has a plurality of spacers arranged between a pair of substrates so that an area density of the spacers arranged in a column direction continuously changes from an edge portion to a predetermined central portion of a display area in a row direction. Accordingly, it becomes possible to maintain the gap between the substrates uniform over the entire display area.

Hereinafter, a liquid crystal display device according to a first embodiment will be explained referring to Figures. In the figures, a left portion of a display panel 11 is shown as a representative. However, other portions in the display area, such as upper, lower and/or right portions are similarly constructed. Therefore, the following discussion is equally applicable to every portion of the display panel 11.

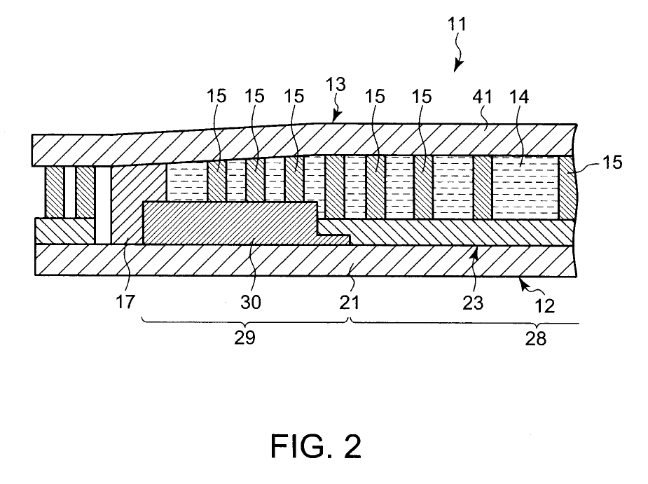

In FIG. 2, a liquid crystal display panel 11 having a display area 28 in a liquid crystal display device includes an array substrate 12 and a counter substrate 13 arranged opposite to the array substrate 12. A plurality of spacers 15 are arranged between the substrates 12 and 13 to maintain a gap between the substrates 12 and 13. A liquid crystal material is injected into the gap as a light modulation layer 14. The array substrate 12 and the counter substrate 13 are attached by a seal element 17 provided to surround the display area 28.

In this exemplary embodiment, a transmissive liquid crystal display panel 11 which has a backlight unit with a surface light source is described. However, as can be appreciated by one of ordinary skill in the art, the present invention also applies to reflective or semi-transmissive type liquid crystal display panels.

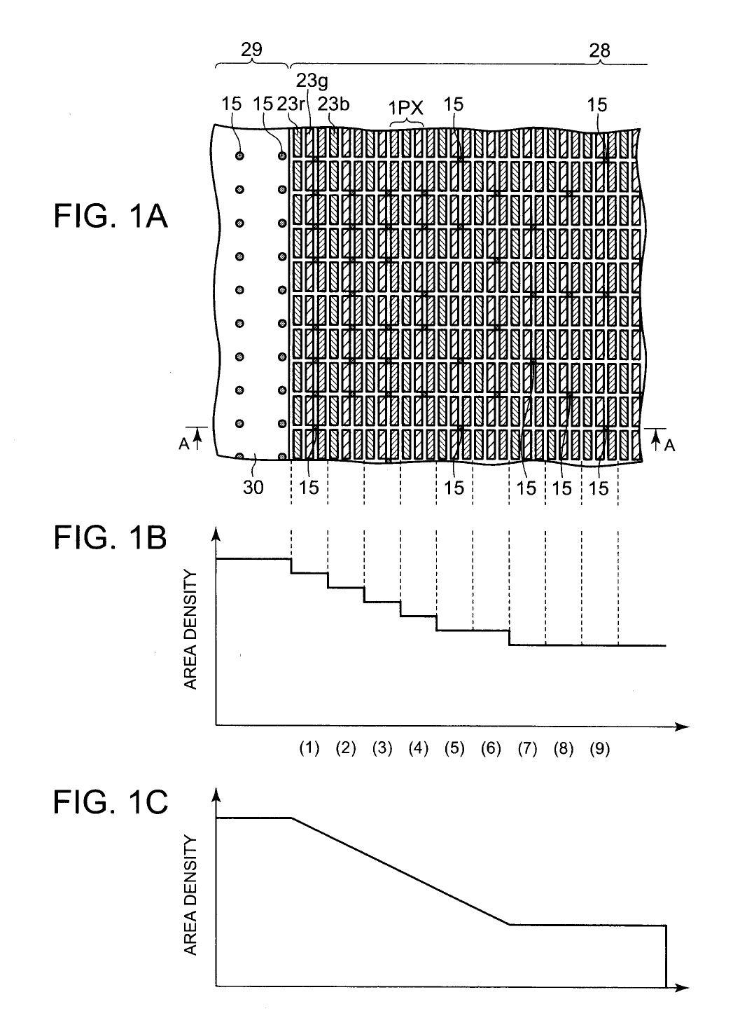

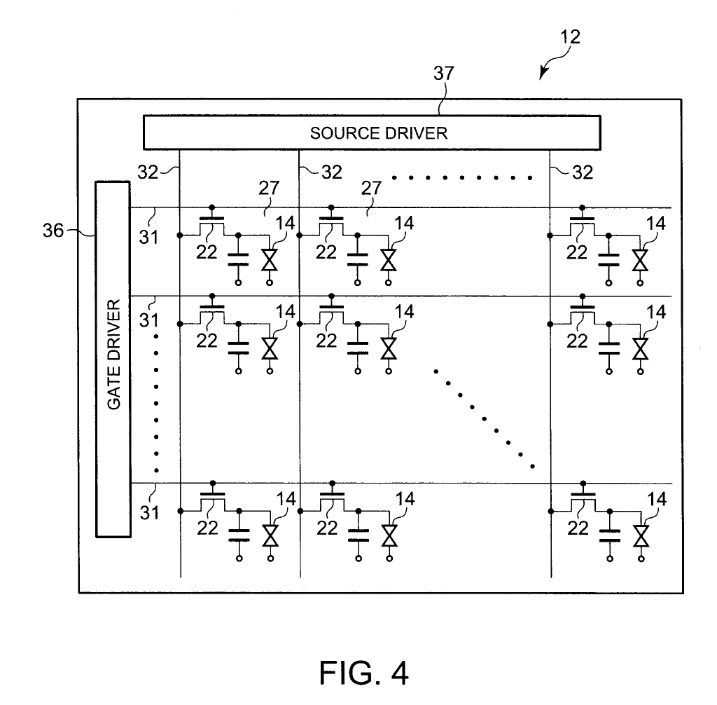

In the array substrate 12, Thin Film Transistors (TFTs) are formed on a transmissive insulating substrate, i.e. a glass substrate 21, as the switching transistors 22 of FIG. 4. Further, in FIG. 1, color filter layers 23 including red 23r, green 23g and blue 23b colored resins are formed on the switching transistors 22 (TFTs). These color filters correspond to red, green and blue sub-pixels in a stripe shape, respectively.

In FIG. 2, respective pixel electrodes (not shown) formed of a transmissive conductive material such as ITO are formed on the red, green and blue colored sub-pixels, 23r, 23g and 23b, and respective pixel electrodes) are connected to the switching transistors 22 through contact holes, which penetrate the red 23r, green 23g and blue 23b colored resins.

In FIG. 1, a plurality of pixels, each including three sub-pixels, are arranged in a matrix to form display area 28 in a rectangular shape. A shield layer 30, which forms a non-display area 29, is formed in a rectangular frame shape adjacent to the seal element 17 provided on an outer periphery of the display area 28.

In FIG. 4, a plurality of pixels 27 are arranged in row and column directions to form a matrix. The gate electrodes of the switching transistors 22 are connected to scan lines 31, the source electrodes are connected to signals lines 32, and the drain electrodes are connected to the liquid crystal layer 14. The switching transistors 22 are switched by the scan signals supplied to the gate electrodes of the switching transistors 22 through the scan lines 31 from a gate driver 36. The image signals are supplied to respective pixel electrodes from a source driver 37 through the signal lines 32 in synchronicity with conductance of the switching transistor 22. According to such operation, an image is displayed by independently switching respective pixels 27.

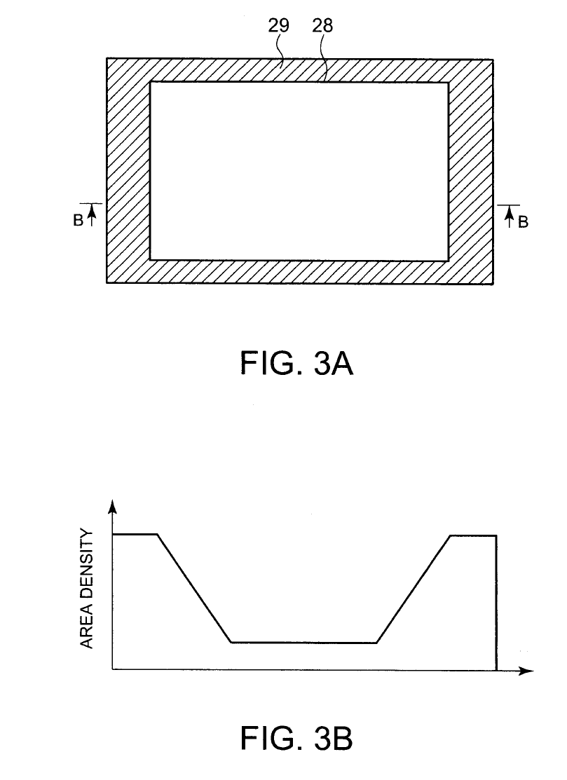

Next, construction of the pixels is described with reference to FIGS. 2, 3A and 3B. As described above, each pixel is formed of adjacent red, green and blue sub-pixels made of colored resins 23r, 23g and 23b. A counter electrode (not shown) formed of transmissive conductive material such as ITO (Indium Tin Oxide) is provided on a surface of a transmissive insulating substrate, such as a glass 41 of the counter substrate 13, as a common electrode for the pixels 27. Further, an alignment film is formed to cover the common electrode formed on glass substrate 41. A liquid crystal layer 14, formed of liquid crystal material as a light modulation layer, is arranged in a gap between the alignment films provided on the surfaces of the array substrate 12 and the counter substrate 13, respectively. Spacers 15 made of, for example, synthetic-resin in a columnar shape are arranged at a crossing area where the scan lines 31 and signal lines 32 cross each other. That is, on shield portions, where light from a back light unit is shielded. The spacers 15 are arranged every three sub-pixels in a row direction.

In FIGS. 2 and 3A and 3B the spacers 15 are arranged with a constant area density in the non-display area 29 located at the peripheral area of the display panel 11, where the gap is relatively small. Further, the area density of the spacers 15 gradually and continuously lowers from an edge portion of the display area 28 to a central portion of the display area 28. The area density of the spacers 15 is set to a predetermined low area density in the central area of the display area 28.

The area density of spacers 15 is a density of spacers 15 arranged in the pixels in the column direction. Specifically, the area density is a value given by:

area density of spacers: (B/A)×(C/D),

where:

A: is a predetermined number of pixels arranged along one column line,

B: is the number of the spacers 15 arranged between adjacent pixels of the predetermined number of pixels arranged along one column line,

C: is the area of each spacer 15 that occupies surfaces of the substrates 12 and 13, and

D: is the area of each pixel in the display area 28.

The area density of the spacers 15 in the non-display area 29 substantially corresponds to the area density of the spacers 15 in the display area 28, although the pixels are not actually formed in the non-display area 29.

For example, the area densities of regions (1) to (6) of FIG. 1B are as follows.

Region (1): 8 pieces/10 pixels×(area of spacer 15)/(area of one pixel),
Region (2): 7 pieces/10 pixels×(area of spacer 15)/(area of one pixel),
Region (3): 6 pieces/10 pixels×(area of spacer 15)/(area of one pixel),
Region (4): 5 pieces/10 pixels×(area of spacer 15)/(area of one pixel),
Region (5): 4 pieces/10 pixels×(area of spacer 15)/(area of one pixel),
Region (6): 4 pieces/10 pixels×(area of spacer 15)/area of one pixel).

In this first exemplary embodiment, the area density of spacers 15 changes in steps along the row direction of the display panel 11. FIG. 1C is a simplified line graph omitting the individual steps in area density of spacers 15 for clarity and to show a trend of distribution of the spacers 15. In other embodiments, density graphs are simplified for clarity.

In this first exemplary embodiment, respective pixels are formed of three sub-pixels R, G, B (not shown) and arranged in one row line, with the spacers 15 arranged between the adjacent sub-pixels in the column direction. The spacers 15 do not shield the modulated light from a back light unit because the spacers 15 are formed between the pixels. The spacers 15 are arranged every three column lines, (i.e. three stripes of the three colored sub-pixels). However, as can be appreciated by one of ordinary skill in the art, the spacers 15 may be arranged every three or six column lines in correspondence with the size of the display.

Next, a manufacturing process according to the first embodiment will be explained. First, scan lines 31, signal lines 32 and the switching transistors 22 (TFTs) are formed on a glass substrate 21 to make an array substrate 12. Then, red colored resist is coated by a spinner on the substrate 12, and the substrate 12 is baked. In an exposure process, the spin coated substrate 12 is developed using a mask pattern, a predetermined ultra violet light, and a developing solution such as TMAH (tetramethylammonium hydride solution of 0.1% weight). The substrate is post-baked after washing and the red colored resist regions 23r having a contact hole is formed. The green resist region 23g and the blue resist region 23b are formed using the same process, which is a color filter layer forming process.

In a pixel electrode manufacturing process, an ITO layer is formed on the colored resist regions 23r, 23g and 23b using a spattering method and the ITO layer is selectively patterned to form a pixel electrode, which is connected to the switching transistors 22 through a contact hole. Next, a shield layer 30 is formed using a similar process to that of forming the colored resist regions 23r, 23g and 23b. Then, an alignment material such as polyimide is coated on the entire surface of the array substrate 12 and treated to make alignment films.

Next, columnar spacers 15 made of compound resin are formed between adjacent pixels on the array substrate 12. The spacers 15 are arranged in the column direction to avoid the pixel electrodes. The spacers 15 are also arranged every three column lines as in FIG. 1. In the first embodiment, the spacers 15 are arranged so that the area density of the spacers 15 is constant in the non-display area 29 surrounding the display area 28. The area density of the spacers 15 is gradually lowered from an edge portion of the display area 28, to a predetermined central portion of the display area 28, and is set to a uniformly low area density in the central area of the display area 28. Accordingly, the gap between the substrates 12 and 13 becomes substantially uniform from the edge portion to the central area of the display area 28.

To manufacture the counter substrate 13, an ITO film is formed as a counter electrode on a surface of the glass substrate 41 by a spattering method. Then, an alignment material such as polyimide is coated on the entire surface of the glass substrate 41 and the alignment treatment is conducted.

After completion of the counter substrate 13, a seal element 17 is coated at an outer periphery of one of the array substrate 12 and the counter substrate 13. Then the liquid crystal material is poured into an area surrounded by the sealing layer 17 on the array substrate 12 or on the counter substrate 13. In the one drop method, excess amounts of the liquid crystal material may be poured. Next, the array substrate 12 and the counter substrate 13 are attached by the seal element 17 in a vacuum condition. The attached substrates are conveyed to a cluster type sealing chamber and are exhausted. Subsequently, the substrates are baked for a predetermined time at a suitable cure temperature. After curing, polarizers (not shown) are provided on respective outer surfaces of the array substrate 12 and the counter substrate 13 to complete the liquid crystal display panel 11.

As mentioned above, according to the first embodiment, spacers 15 are arranged so that the area density changes from the edge portion to a predetermined central portion of the display area 28 in the row direction. Accordingly, it becomes possible to suppress abrupt changes of the gap between the array substrate 12 and the counter substrate 13, resulting in decreased gap variation in the display area 28.

In this first embodiment in which the gap in the non-display area 29 is smaller than that of the display area 28, it becomes possible to maintain the gap between the substrates 12 and 13 substantially uniform for entire area in the display area 28 by setting the area density so as to continuously decreases from the edge portion to the predetermined central portion in the display area 28. Accordingly, it becomes possible to maintain the gap between the substrates uniform in the entire display area.

When the liquid crystal display panel is manufactured by the one drop method in which the substrates 12 and 13 are attached after dropping the liquid crystal material, an excessive amount of the liquid crystal material may be dropped to prevent generation of bubbles. In such a case, the central portion of the display area 28 is heaped with the dropped liquid crystal material, which may result in the variation of the gap between the substrates 12 and 13 from the central portion to the edge portion of the display area 28. Accordingly, the present invention allows reliable suppression of the variation in the gap between the substrates 12 and 13 by setting the area density of the spacers 15 arranged at the edge portion of the display area 28 to a larger density than the density of the spacers 15 in the central portion of the display area 28. This reduces the percentage of manufacturing defects caused by gap variations in the display area 28, resulting in a high quality liquid crystal display panel 11.

Moreover, since the columnar spacers 15 are used, the spacers 15 can be arranged with a higher accuracy of several micro meters compared to a method that uses spherical spacers and disperses them from a nozzle of a spreader. Accordingly, the display defect at the location where the area density of the spacers 15 is higher is suppressed.

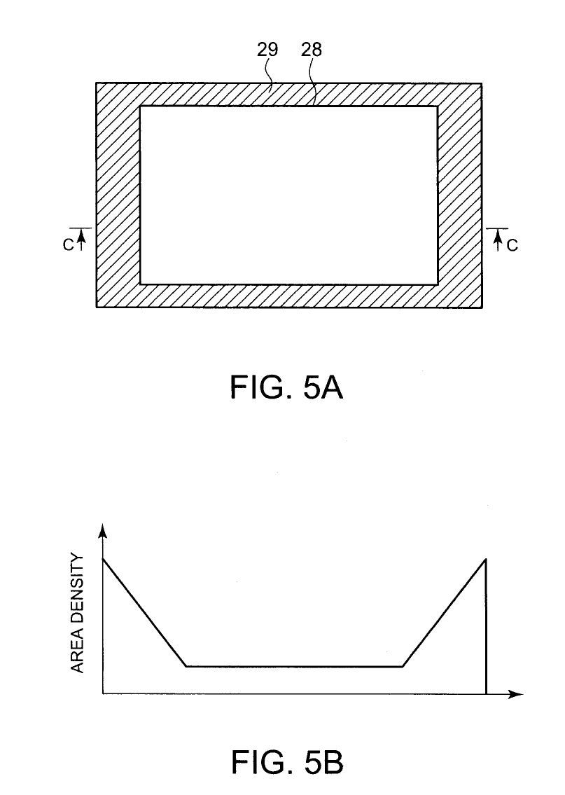

Next, a second exemplary embodiment will be explained referring to FIGS. 5A and 5B. In this embodiment, the spacers 15 are arranged so that the area density of the spacers 15 continuously becomes smaller from the edge portion of the non-display area 29 to a predetermined central portion of the display area 28, where the density of the spacers 15 becomes constant. That is, the spacers 15 in the non-display area 29 are arranged so that the area density of the spacers 15 gradually becomes small from the edge portion of the non-display area 29 to the display area 28. The spacers 15 in the display area 28 are arranged successively so that the area density of the spacers 15 becomes gradually small from the edge portion to the predetermined central portion of the display area 28, and becomes substantially constant in the central area of the display area 28 as in FIG. 5B.

According to the second exemplary embodiment, the area density of the spacers 15 in the non-display area 29 is also continuously reduced from the edge portion of the non-display area 29 to the edge portion of the display area 28. Therefore, the variation of the gap between the substrates 12 and 13 around the edge portion in the display area 28 is more reliably suppressed.

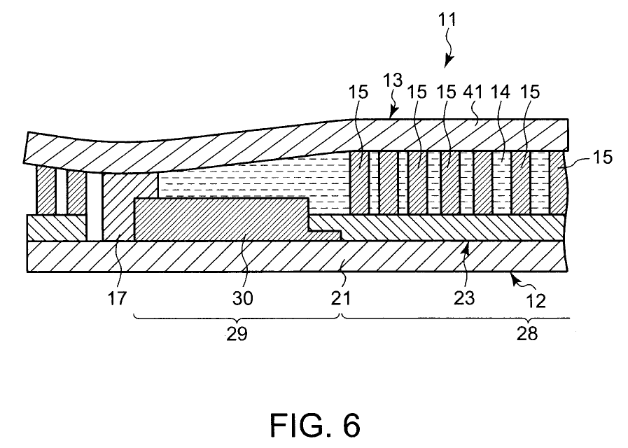

Next, a third exemplary embodiment will be explained referring to FIG. 6. In this embodiment, the spacers 15 are formed of the same material and using the same manufacturing process as the shield layer 30. That is, the spacers 15 are formed at the same time as the shield layer 30. Therefore, the spacers 15 are not formed on the shield layer 30. However, the same effect as described with reference to the other exemplary embodiments is obtained by arranging the spacers 15 so that the area density decreases from the edge portion of the display area 28 to a predetermined central portion in the display area 28. Further, the third exemplary embodiment allows a high quality display with reduced gap variations in the display area 28 to be produced with fewer manufacturing steps and at a lower cost.

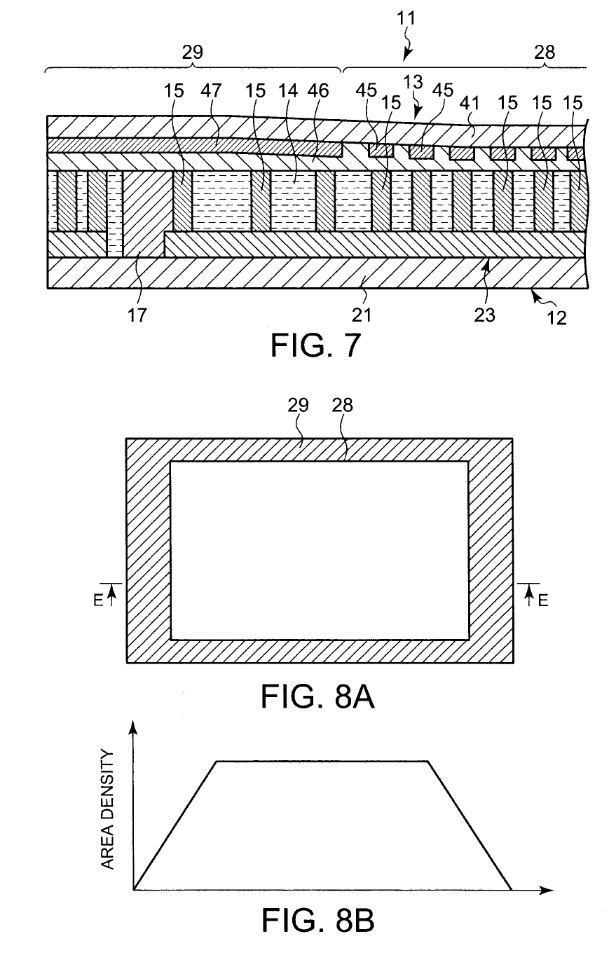

FIGS. 7, 8A and 8B correspond to a fourth exemplary embodiment of the present invention. In this embodiment, the shield layer 47 is formed on the counter substrate 13 and is covered with an overcoat layer 46. The shield layer 47 is formed of the same material, for example synthetic resin, as the black matrix layers 45. The shield layer 47 is formed at locations corresponding to the signal lines 32 or the scan lines 31. The overcoat layer 46 is a planarization layer formed of a transmissive organic insulating material.

The spacers 15 are arranged so that the area density gradually increases across the non-display area 29 from an edge portion of the non-display area 29 to the display area 28. That is, the spacers 15 are arranged so that the area density gradually and linearly increases from the edge portion of the non-display area 29 to the display area 28. Further, the area density increases continuously from the non-display area 29 to a predetermined central portion of the display area 28, where the density of the spacers 15 becomes constant with a high value.

In this fourth embodiment, since both shield layer 47 and black matrix layer 45 are arranged on the counter substrate 13 and are covered with the overcoat layer 46, the gap between the substrates 12 and 13 in the non-display area 29 is larger than that of the display area 28. The variation of the gap can be reduced by setting the area density of the spacers 15 so as to continuously increase from the edge portion to a predetermined central portion in the display area 28.

In the above exemplary embodiments, other light modulation layers can be used in place of the liquid crystal layer 14 as can be appreciated by one of ordinary skill in the art. Moreover, the area density of the gap formed of the spacers 15 may be set so as to increase or decrease in a polygonal line or a curve line in accordance with the relationship in the gap between the edge portion and the central area in the display area 28.

According to the present invention, the variation of the gaps between the substrates 12 and 13 in the display area 28 is decreased and a high quality display is obtained by arranging the spacers 15 so as to continuously change in density from the edge portion to the central area of the display area 28. Therefore, a high quality display can be supplied.

The present invention is not limited to the above described embodiments. As can be appreciated by one of ordinary skill in the art, the structural elements can be modified without departing from the spirit of the invention. For example, some structural elements may be omitted, or structural elements described in the different embodiments may be combined. It is therefore to be understood that within the scope of the appended claims, the present invention may be practiced otherwise than as specifically described herein.

What is claimed is:

1. A display device, comprising:
a first substrate arranged opposite to a second substrate;
a light modulation layer interposed between the first and second substrates;
a plurality of spacers arranged between the first and second substrates, the plurality of spacers maintaining a gap between the first and second substrates; and
a display area formed by the first and second substrates, the light modulation layer and the plurality of spacers, the display area including a plurality of pixels extending in row and column directions to form a matrix, and
wherein an area density of the spacers provided in the display area continuously changes from an edge portion to a predetermined portion of the display area, the area density of spacers being given by:
(B/A)×(C/D),
where
A is a predetermined number of pixels arranged along one column line,
B is a number of spacers arranged between adjacent pixels of the predetermined number of pixels arranged along the one column line,
C is an area of each spacer that occupies surfaces of the first and second substrates, and
D is an area of each pixel in the display area.

2. The display device according to claim 1, wherein the area density of the spacers continuously increases from an edge portion to a central portion in the display area.

3. The display device according to claim 1, wherein the area density of the spacers continuously decreases from an edge portion to a central portion in the display area.

4. The display device according to claim 1, wherein the spacers are columnar spacers.

5. The display device according to claim 1, further comprising:
a non-display area arranged at a peripheral portion of the display area and surrounding the display area.

6. The display device according to claim 5, wherein the non-display area includes a shield layer.

7. The display device according to claim 6, wherein the spacers are formed of the same material as the shield layer.

8. The display device according to claim 5, wherein an area density of the spacers in the non-display area is uniform and substantially corresponds to the area density of the spacers in the central portion of the display area.

9. The display device according to claim 5, wherein an area density of the spacers in the non-display area decreases from an edge portion of the non-display area to the display area, the density of the spacers in the display area further decreasing to a predetermined central portion of the display area, the area density of the spacers in the non-display area substantially corresponding to the area density of the spacers in the center portion of the display area.

10. A liquid crystal display device including a liquid crystal display panel, comprising:
a first substrate formed in a rectangular shape;
a second substrate opposite to the first substrate;
a liquid crystal layer arranged between the first and second substrates;
a display area formed by the first and second substrates and the liquid crystal layer, the display area including a plurality of pixels extending in row and column directions to form a matrix;
a non-display area arranged at a peripheral portion of the display area and surrounding the display area; and
a plurality of spacers arranged between the first and second substrates, an area density of the spacers continuously changing from an edge portion to a predetermined central portion of the display area, and
wherein the area density of the spacers is given by:
(B/A)×(C/D),
where
A is a predetermined number of pixels arranged in one column line,
B is a number of spacers arranged adjacent to pixels of the predetermined number of pixels arranged in the one column line,
C is an area of each spacer which occupies surfaces of the first and second substrates, and
D is an area of each pixel in the display area.

11. The liquid crystal display device according to claim 10, wherein the area density of the spacers continuously decreases from an edge portion to a central portion of the display area.

12. The liquid crystal display device according to claim 10, wherein the area density of the spacers continuously increases from an edge portion to a central portion of the display area.

13. The liquid crystal display device according to claim 10, further comprising:
a non-display area arranged at a peripheral portion of the display area and surrounding the display area.

14. The display device according to claim 13, wherein an area density of the spacers in the non-display area decreases from an edge portion of the non-display area to the display area, the area density of the spacers further decreasing to a predetermined central portion of the display area, the area density of the spacers in the non-display area substantially corresponding to the area density of the spacers in the center portion of the display area.

15. The display device according to claim 10, wherein the spacers are columnar spacers.

16. A liquid crystal display device including a liquid crystal display panel, comprising:
a first substrate formed in a rectangular shape and including switching transistors;
a second substrate opposite to the first substrate;
a liquid crystal layer arranged between the first and second substrates;
a display area formed by the first and second substrates and the liquid crystal layer, the display area including a plurality of pixels arranged in row and column directions to form a matrix;
a non-display area arranged at a peripheral portion of the display panel and surrounding the display area;
a plurality of spacers arranged between the first and second substrates in the display area;
a shield layer formed on the second substrate in a peripheral portion thereof, and
an overcoat layer formed on the second substrate, the overcoat layer covering the shield layer, and
wherein an area density of the spacers in the display area continuously changes from an edge portion to a predetermined portion of the display area, e the area density of the spacers being given by:
(B/A)×(C/D),
where
A is a predetermined number of pixels arranged in one column line,
B is a number of spacers arranged adjacent to pixels of the predetermined number of pixels arranged in the one column line,
C is an area of each spacer which occupies surfaces of the first and second substrates, and
D is an area of each pixel in the display area.

17. The display device according to claim 16, wherein an area density of the spacers in the non-display area increases from an edge portion of the non-display area to the display area, the area density of the spacers further increasing to a predetermined central portion of the display area, the area density of the spacers in the non-display area substantially corresponding to the area density of the spacers in the central portion of the display area.

18. The display device according to claim 16, wherein the spacers are columnar spacers.

19. A liquid crystal display device including a liquid crystal display panel, comprising:
a first substrate formed in a rectangular shape and including switching transistors, signal lines extending in a row direction and scan lines extending in a column direction, the signal lines crossing the scan lines;
a second substrate opposite to the first substrate;
a liquid crystal display layer arranged between the first and second substrates;
a display area formed by the first and second substrates and the liquid crystal display layer, the display area including a plurality of pixels arranged in row and column directions, each pixel including a plurality of different colored sub-pixels arranged alternately in the row direction; and
a plurality of spacers arranged between the first and second substrates in the display area, and
wherein an area density of the spacers provided in the display area continuously changes from an edge portion to an predetermined portion of the display area, and
where the area density is given by:
(B/A)×(C/D),
where
A is a predetermined number of pixels arranged in one column line,
B is a number of spacers arranged adjacent to pixels of the predetermined number of pixels arranged in the one column line, the pixels including the plurality of sub-pixels,
C is an area of each spacer which occupies surfaces of the firs and second substrates, and
D is an area of each pixel in the display area.

20. The display device according to claim 19, further comprising:
a non-display area arranged at a peripheral portion of the display area and surrounding the display area.

21. The display device according to claim 20, wherein an area density of the spacers in the non-display area decreases from an edge portion of the non-display area to the display area, the area density of the spacers further decreasing to a predetermined central portion of the display area, the area density of the spacers in the non-display area substantially corresponding to the area density of the spacers in the predetermined central portion of the display area.

22. The display device according to claim 20, wherein the non-display area further includes a shield layer and the spacers are formed of the same material as the shield layer.

23. A liquid crystal display device including a liquid crystal display panel, comprising:
a first substrate formed in a rectangular shape and including switching transistors, signal lines extending in a row direction and scan lines extending in a column direction, the signal lines crossing the scan lines;
a second substrate opposite to the first substrate;
a liquid crystal layer arranged between the first and second substrates;
a display area formed by the first and second substrates and the liquid crystal layer, the display area including a plurality of pixels arranged in a matrix, each pixel including red, green and blue sub-pixels alternately arranged in the row direction;
a non-display area arranged at a peripheral portion of the display area and surrounding the display area;
a plurality of spacers arranged between the first and second substrates in the display area, an area density of the spacers continuously changing from an edge portion to a predetermined portion of the display area;
a shield layer formed in a peripheral portion of the second substrate; and
an overcoat layer covering the shield layer, and, wherein the spacers are arranged between adjacent pixels in the column direction, the area density of the spacers being given by:
(B/A)×(C/D),
where
A is a predetermined number of pixels arranged in one column line, each of the pixels including red, green and blue sub-pixels arranged alternately in the row direction,
B is a number of spacers arranged adjacent to pixels of the predetermined number of pixels arranged in the one column line,
C is an area of each spacer which occupies surfaces of the first and second substrates, and D is an area of each pixel in the display area.

24. The display device according to claim 23, wherein the spacers are columnar spacers.

25. A method for manufacturing a liquid crystal display device including pixels extending in row and column directions to form a matrix, the method comprising:
forming scan lines, signal lines and switching transistors on an array substrate, each switching transistor corresponding to a pixel;
connecting the switching transistors to the scan lines and signal lines;
forming color filter layers formed on the switching transistors;
forming columnar spacers between adjacent pixels on a counter substrate, the columnar spacers maintaining a gap between the array substrate and the counter substrate, the counter substrate being opposite the array substrate;
opposing the counter substrate and the array substrate, and
injecting liquid crystal material into the gap between the counter substrate and the array substrate, and
wherein an area density of the spacers provided in the display area continuously changes from an edge portion to a predetermined portion of the display area, the area density being given by:
(B/A)×(C/D),
where
A is a predetermined number of pixels arranged in one column line,
B is a number of the spacers arranged adjacent to pixels of the predetermined number of pixels arranged in the one column line,
C is an area of each spacer which occupies surfaces of the first and second substrates, and
D is an area of each pixel in the display area.

26. The method of claim 25, further comprising:
forming a shield layer in a peripheral portion of the display panel on the counter substrate.

27. The method of claim 26, wherein the liquid crystal display device includes an overcoat layer formed on the shield layer and the spacers are formed between the overcoat layer on the counter substrate and the color filter layers on the array substrate.
